(19) United States
(12) Patent Application Publication
(10) Pub. No.: US 2024/0007355 A1
(43) Pub. Date: Jan. 4, 2024

(54) MAPPING NETWORK CONNECTIONS BY TCP/IP DATA AGGREGATION

(71) Applicant: Royal Bank of Canada, Toronto (CA)

(72) Inventors: Riyaad Ali, Toronto (CA); Marat Khandros, New York, NY (US)

(21) Appl. No.: 18/345,352

(22) Filed: Jun. 30, 2023

Related U.S. Application Data
(60) Provisional application No. 63/357,402, filed on Jun. 30, 2022.

(51) Int. Cl. H04L 41/12

(52) U.S. Cl. CPC H04L 41/12

(57) ABSTRACT

A method for mapping network connections among a plurality of servers comprises invoking inbuilt OS-native utilities on the servers to identify TCP/IP connections on the servers, parsing the TCP/IP connections into a common representation format, and using the common representation format to map dependencies in the network by differentiating the TCP/IP connections into inbound TCP/IP connections and outbound TCP/IP connections. Local scripts may be used to invoke the inbuilt OS-native utilities and parse the TCP/IP connections into the common representation format.

### CROSS-REFERENCE TO RELATED APPLICATION

This application claims priority to U.S. Provisional Application No. 63/357,402 filed on Jun. 30, 2022 and which is incorporated herein by reference.

### TECHNICAL FIELD

The present disclosure relates to mapping of network connections.

### BACKGROUND

The ability to trace the attributes of an application by mapping dependencies in network connections can provide visibility to dependent infrastructure components of a given application, which can aid in diagnosing and resolving problems.

There are many available tools and utilities that claim to be a single source of truth when it comes to tracking connections between aspects of network infrastructure. However, these tools often require manual human intervention to “connect the dots” between network services. Moreover, many such technologies are generally expensive, rigid in functionality, and do not easily open their data for consumption.

It would be desirable to provide a technology to dynamically map network infrastructure dependencies in a lightweight fashion, with data that is open and accessible for ingestion and use, with little or no human intervention once the system is established.

### SUMMARY

In one aspect, a method for mapping network connections among a plurality of servers is provided. The method comprises invoking a first inbuilt OS-native utility on a first one of the servers to identify first TCP/IP connections on the first one of the servers and invoking a second inbuilt OS-native utility on a second one of the servers to identify second TCP/IP connections on the second one of the servers. The first TCP/IP connections and the second TCP/IP connections are parsed into a common representation format, and the common representation format is used to map dependencies in the network by differentiating the first TCP/IP connections into first inbound TCP/IP connections and first outbound TCP/IP connections and differentiating the second TCP/IP connections into second inbound TCP/IP connections and second outbound TCP/IP connections.

In some embodiments, the first inbuilt OS-native utility is invoked by running a first OS-native script on the first one of the servers and the second inbuilt OS-native utility is invoked by running a second OS-native script on the second one of the servers, and parsing the first TCP/IP connections into the common representation format occurs on the first server and parsing the second outbound TCP/IP connections into the common representation format occurs on the second server. In particular embodiments, the first one of the servers runs a first operating system and the second one of the servers runs a second operating system; the first operating system is different from the second operating system. The first OS-native script is native to the first operating system and the second OS-native script is native to the second operating system.

In some embodiments, the first one of the servers runs a first operating system and the second one of the servers runs a second operating system and the first operating system is different from the second operating system; the first inbuilt OS-native utility is native to the first operating system and the second inbuilt OS-native utility is native to the second operating system. In some particular embodiments, the first operating system is a Windows operating system and the second operating system is a Linux operating system.

In some embodiments, the plurality of servers comprises at least three servers, and the method further comprises invoking a third inbuilt OS-native utility on a third one of the servers to identify third TCP/IP connections on the third one of the servers and parsing the third TCP/IP connections into the common representation format, and using the common representation format to map dependencies in the network further comprises differentiating the third TCP/IP connections into third inbound TCP/IP connections and third outbound TCP/IP connections.

In some embodiments, the third inbuilt OS-native utility is invoked by running a third OS-native script on the third one of the servers and parsing the third TCP/IP connections into the common representation format occurs on the third server.

The plurality of servers may be ten or more servers, fifty or more servers, one hundred or more servers, or one thousand or more servers.

In some embodiments, the first inbuilt OS-native utility on the first one of the servers retrieves a first connection table and all active TCP/IP connections for the first one of the servers are extracted from the first connection table.

In some embodiments, differentiating the first TCP/IP connections into first inbound TCP/IP connections and first outbound TCP/IP connections comprises executing a network engineering protocol logic layer on the common representation format: where an active one of the first TCP/IP connections is made to one of the first server's IP addresses and bound to one of the first server's listening ports and a local port number is lower than a remote port number, that active one of the first TCP/IP connections is considered to be an inbound connection; otherwise that active one of the first TCP/IP connections is considered to be an outbound connection.

In some embodiments, the first inbuilt OS-native utility is a NETSTAT utility.

In some embodiments, the mapping uses the first inbound TCP/IP connections, the first outbound TCP/IP connections, the second inbound TCP/IP connections and the second outbound TCP/IP connections to generate host dependencies based on directions of the connections. In particular embodiments, the plurality of servers comprises initially known ones of the servers from an initial list and additional ones of the servers omitted from the initial list and identified from the host dependencies. In still more particular embodiments, a security test is applied to the additional ones of the servers omitted from the initial list and identified from the host dependencies, and any of the ones of the servers omitted from the initial list and identified from the host dependencies that fail the security test are flagged as a security risk.

In another aspect, a computer program product comprises a tangible, non-transitory computer readable medium containing instructions which, when executed by at least one processor of a data processing system, cause the data processing system to implement the method as described above.

In still another aspect, a data processing system comprises at least one processor and memory coupled to the at least one processor, wherein the memory stores instructions which, when executed by the at least one processor, cause the data processing system to implement the method as described above.

### BRIEF DESCRIPTION OF THE DRAWINGS

These and other features will become more apparent from the following description in which reference is made to the appended drawings wherein:

FIG. 1 is a simplified block diagram that schematically represents an illustrative simplified network;

FIG. 2 is a flow chart showing an illustrative method for mapping network connections among a plurality of servers;

FIG. 2A is a flow chart showing another illustrative method for mapping network connections among a plurality of servers;

FIG. 3 is an entity relationship diagram for an illustrative dependency database;

FIG. 4 is an application flow diagram for an illustrative implementation of a network mapping system;

FIG. 5 is an illustrative GUI presenting a connection table; and

FIG. 6 is a block diagram showing an illustrative computer system in respect of which aspects of the present technology may be implemented.

### DETAILED DESCRIPTION

The present disclosure is directed to the use of Transmission Control Protocol/Internet Protocol (TCP/IP) connection data, obtained directly from host devices (e.g. server computers), as the source of truth for host dependency. (The terms “host” and “server” are used interchangeably herein.) TCP/IP is the default suite of protocols used to connect devices that communicate on a network (e.g. Internet or a private network or “intranet”), and is standards-based. Virtually any host device with network capability will employ the TCP/IP protocol, as it is a common standard used globally. Connection data for a given host can be obtained using built-in operating system (OS) tools such as NETSTAT; this connection data will demonstrate all inbound and outbound connections for that host device. By aggregating this connection data across a plurality of hosts, dependencies between the hosts can be illuminated with little or no human intervention. The systems and methods according to the present disclosure calculate host dependencies based on this standardized TCP/IP connection data, which provides extensibility and can incorporate a wide range of network-capable hosts into its database. The use of standardized TCP/IP connection data also avoids the need for specialized network “tap” hardware to collect connection data. Moreover, because the mappings are based on real connection data, as opposed to metadata, mapped relationships are true and not simply loose associations. The data can be collected using existing tools, and can also be made available freely to other applications via application programming interface (API) or other suitable interface. This functionality helps drive down incident recovery times, as distributed components of any given application or system can be illuminated.

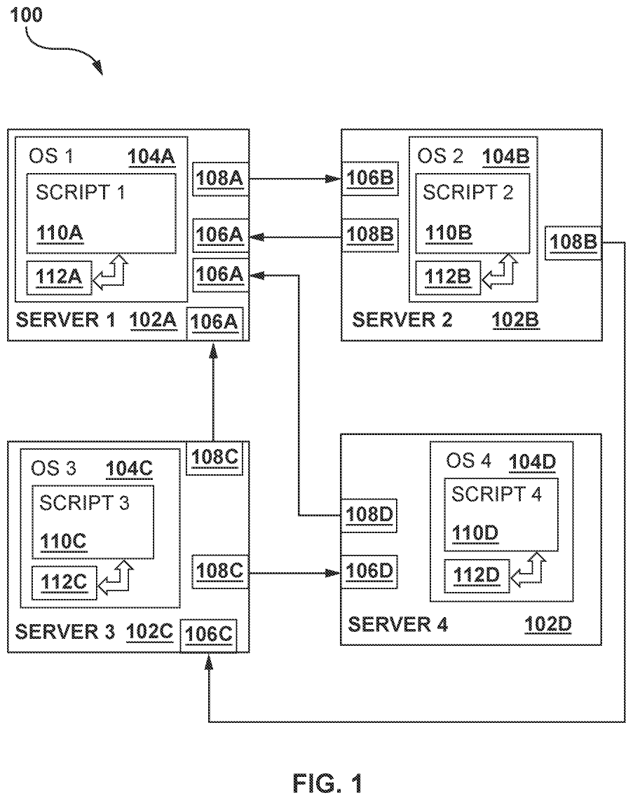

Reference is now made to FIG. 1, in which a simplified illustrative network is indicated generally at reference 100. The network 100 is made up of four servers, namely Server 1 denoted by reference 102A, Server 2 denoted by reference 102B, Server 3 denoted by reference 102C and Server 4 denoted by reference 102D. The servers 102A, 102B, 102C, 102D each run an operating system (“OS”). Server 1 102A runs a first OS denoted by reference 104A, Server 2 102B runs a second OS denoted by reference 104B, Server 3 102C runs a third OS denoted by reference 104C and Server 4 102D runs a fourth OS denoted by reference 104D. The operating systems 104A, 104B, 104C, 104D may all be the same operating system, or may all be different operating systems, or may be a mix of various operating systems (or versions of operating systems). Examples of operating systems include, but are not limited to, versions of macOS® Server, UNIX (including AIX), Linux® and Windows®. The operating systems 104A, 104B, 104C, 104D are software that manage hardware and software resources on the servers 102A, 102B, 102C, 102D, and provide common services for other computer programs executing on the servers 102A, 102B, 102C, 102D.

The servers 102A, 102B, 102C, 102D execute various application programs (not shown), which may provide services to application programs on other ones of the servers 102A, 102B, 102C, 102D, or to other computers. In this respect, the servers 102A, 102B, 102C, 102D each have respective inbound TCP/IP connections 106A, 106B, 106C, 106D and outbound TCP/IP connections 108A, 108B, 108C, 108D. An inbound TCP/IP connection is one in which one computer receives information or requests from another computer, and an outbound TCP/IP connection is one in which one computer provides information or requests to another computer. Thus, it will be appreciated that an inbound TCP/IP connection 106A, 106B, 106C, 106D for one of the servers 102A, 102B, 102C, 102D may correspond to an outbound TCP/IP connection 108A, 108B, 108C, 108D from another one of the servers 102A, 102B, 102C, 102D. Further, the terms “server” and “host”, as used herein, are not intended to be limiting, and encompass any computing device that can communicate via TCP/IP and which implements a suitable utility to retrieve a current connection table. For example, certain “Internet-of-Things” (IoT) devices are contemplated within this definition of “server” and “host”. For example, Internet-enabled cameras, sensors (e.g. environmental sensors, entry sensors, fire or smoke sensors), wireless access points and the like within a data center may communicate via TCP/IP and implement a suitable utility to retrieve a current connection table and thus may be considered a server. Similarly, a “smart home” arrangement may include devices that function as a server, such as connected lights, connected appliances (e.g. an Internet-enabled refrigerator or air conditioner), among others, such that aspects of the present disclosure may be applied in that context as well. Likewise, vehicles (e.g. autonomous vehicles) may function as servers that can be mapped according to aspects of the present disclosure. Accordingly, while particularly preferred embodiments of the present disclosure are applied within an intranet environment which is secured from the larger Internet (e.g. incoming traffic policed by perimeter routers, etc.), aspects of the present disclosure may be applied where servers communicate across multiple networks.

Each server 102A, 104A, 106A, 108A has a respective OS-native script 110A, 110B, 110C, 110D that can be called remotely and, when called, will invoke a respective inbuilt OS-native utility 112A, 112B, 112C, 112D to both list the active connection table and all configured IP addresses on the respective server 102A, 102B, 102C, 102D. The term “OS-native”, as used in reference to the scripts 110A, 110B, 110C, 110D, means that the script is specifically configured to execute within a particular OS environment (e.g. macOS, Linux, Windows, UNIX, etc.).

The term “inbuilt OS-native utility” refers to a utility provided within a particular OS, that is, it is part of the OS. For example, for the Linux OS and the AIX OS, the inbuilt OS-native utilities that would be invoked may be the NETSTAT utility and the IFCONFIG utility; the Linux OS could also use the IP command. The use of the NETSTAT command limits the scope of the information gathered on each server 102A, 102B, 102C, 102D, to reduce adverse impact on performance. For the Windows OS, PowerShell® (native to the Windows OS) can be used and the inbuilt OS-native utilities that would be invoked may be the “Get-NetIPAddress” and “Get-NetTCPConnection”. Accordingly, a particular inbuilt OS-native utility will be native to a particular operating system; even if the same command is used to invoke the utility, execution of the utility is different for each operating system.

Thus, in the illustrated embodiment, each script 110A, 110B, 110C, 110D identifies the TCP/IP connections 106A, 108A, 106B, 108B, 106C, 108C, 106D, 108D on the respective servers 102A, 102B, 102C, 102D by running an inbuilt OS-native utility 112A, 112B, 112C, 112D on the respective the server 102A, 102B, 102C, 102D to retrieve a connection table and extracting, from the connection table, all active TCP/IP connections. Each script 110A, 110B, 110C, 110D will filter out failed or attempted connections, and only preserve connections that were actually established. Each script 110A, 110B, 110C, 110D will also filter out user diagram protocol (UDP) connections, and preserve TCP connections only.

The network 100 shown in FIG. 1 is simplified for purposes of illustration. While manual mapping of the inbound TCP/IP connections 106A, 106B, 106C, 106D and outbound TCP/IP connections 108A, 108B, 108C, 108D would be trivial for such a simplified network, a real-world network with dozens, hundreds or thousands of servers, and hundreds, thousands or even tens of thousands of inbound TCP/IP connections and outbound TCP/IP connections, could not be so easily mapped.

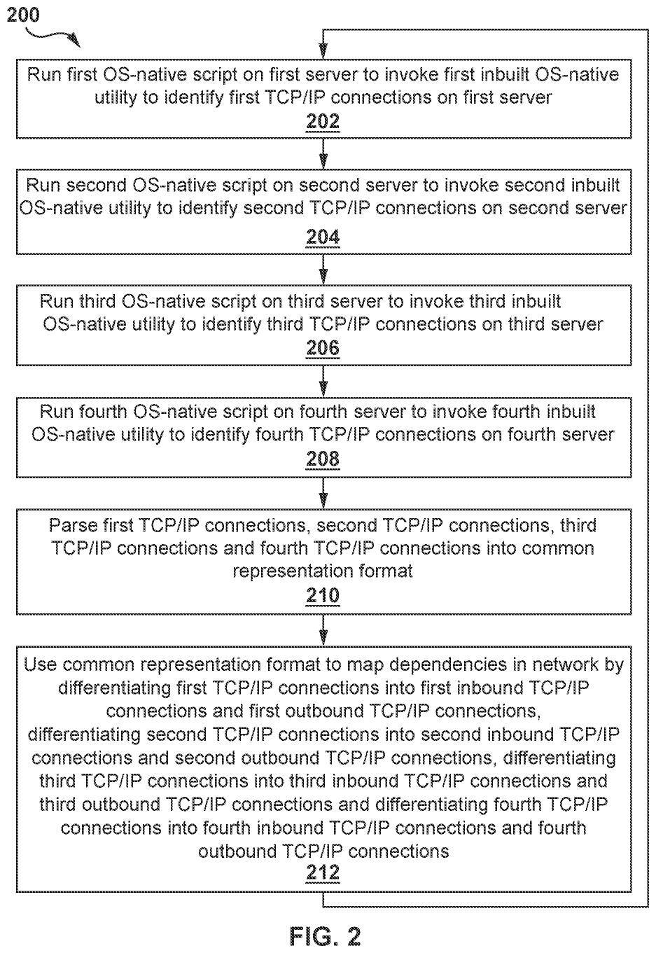

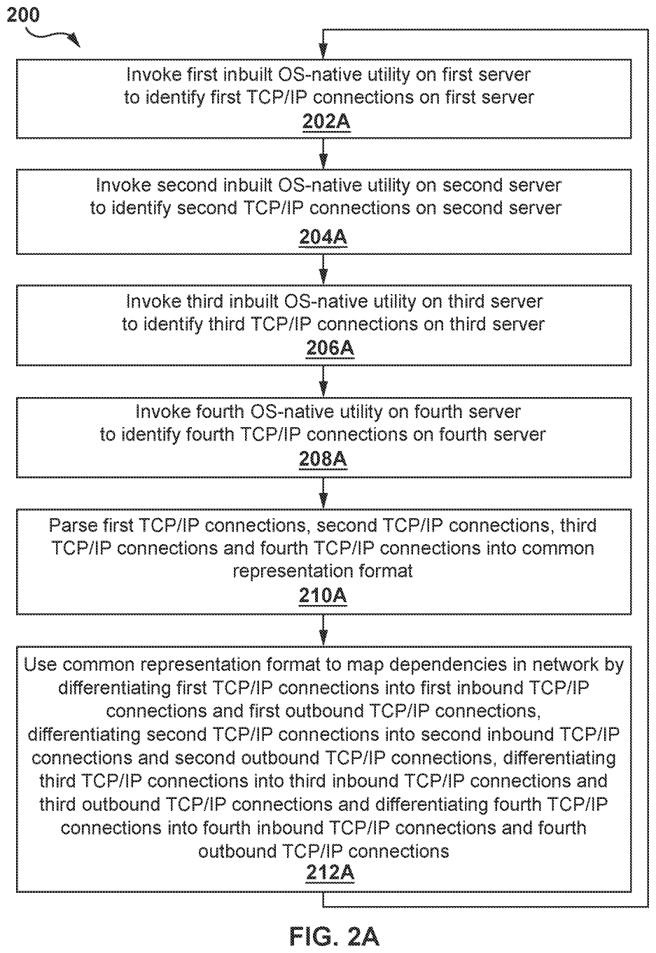

Reference is now made to FIG. 2, in which an illustrative method for mapping network connections among a plurality of servers is indicated generally at 200, in addition to FIG. 1. The method 200 is described for illustrative purposes in the context of the representative network 100 of FIG. 1 (four servers 102A, 102B, 102C, 102D), although it is not so limited. Methods according to the present disclosure may be performed for any network comprising two or more servers; so long as sufficient connectivity and processing capacity is provided, there is no upper limit on the number of servers. For example, the plurality of servers to which the systems and methods described herein may be applied may be at least ten servers, at least fifty servers, at least one hundred servers, at least one thousand servers, or more.

At step 202, the method 200 runs the first OS-native script 110A on the first server 102A, which invokes the first inbuilt OS-native utility 112A to identify first TCP/IP connections 106A, 108A on the first server 102A. At step 204, the method 200 runs the second OS-native script 110B on the second server 102B, which invokes the second inbuilt OS-native utility 112B to identify second TCP/IP connections 106B, 108B on the second server 102B. At step 206, the method 200 runs the third OS-native script 110C on the third server 102C, which invokes the third inbuilt OS-native utility 112C to identify third TCP/IP connections 106C, 108C on the third server 102C. At step 208, the method 200 runs the fourth OS-native script 110D on the fourth server 102D, which invokes the fourth inbuilt OS-native utility 112D to identify fourth TCP/IP connections 106D, 108D on the fourth server 102D. Steps 202, 204, 206 and 208 may be performed sequentially, or in parallel, or in a combination of sequential and parallel execution, and/or in a different order than shown in FIG. 2.

At step 210, the method 200 parses the first TCP/IP connections 106A, 108A, the second TCP/IP connections 106B, 108B, the third TCP/IP connections 106C, 108C and the fourth TCP/IP connections 106D, 108D into a common representation format. While shown for simplicity of illustration as a single step following completion of steps 202, 204, 206 and 208 this is not intended to be limiting. For example, in some embodiments separate parsing steps may follow each of steps 202, 204, 206 and 208.

The OS-native scripts 110A, 110B, 110C, 110D may obtain the entire output (e.g. connection table) of the OS-native utility on the respective server 102A, 102B, 102C, 102D and transmit this entire output to a central system to be parsed into the common representation format on that central system.

At step 212, the method 200 uses the common representation format to map dependencies in the network by differentiating the first TCP/IP connections 106A, 108A into first inbound TCP/IP connections 106A and first outbound TCP/IP connections 108A, differentiating the second TCP/IP connections 106B, 108B into second inbound TCP/IP connections 106B and second outbound TCP/IP connections 108B, differentiating the third TCP/IP connections 106C, 108C into third inbound TCP/IP connections 106C and third outbound TCP/IP connections 108C, and differentiating the fourth TCP/IP connections 106D, 108D into fourth inbound TCP/IP connections 106D and fourth outbound TCP/IP connections 108D.

It is also contemplated that the OS-native scripts 110A, 110B, 110C, 110D may be omitted, and the inbuilt OS-native utilities 112A, 112B, 112C, 112D may be invoked remotely by a central system without local scripts, with the output being parsed into the common representation format on that central system. In such an embodiment, as shown in FIG. 2A, an adapted form of the method 200, denoted by reference 200A, would operate absent local scripts. Thus at step 202A the method 200A invokes the first inbuilt OS-native utility 112A on the first server 102A to identify the first TCP/IP connections 106A, 108A on the first server 102A, at step 204A the method 200A invokes the second inbuilt OS-native utility 112B on the second server 102B to identify the second TCP/IP connections 106B, 108B on the second server 102B, at step 206A the method 200A invokes the third inbuilt OS-native utility 112C on the third server 102C to identify the third TCP/IP connections 106C, 108C on the third server 102C and at step 208A the method 200A invokes the fourth inbuilt OS-native utility 112D on the fourth server 102D to identify the fourth TCP/IP connections 106D, 108D on the fourth server 102D. Steps 202A, 204A, 206A and 208A may be performed sequentially, or in parallel, or in a combination of sequential and parallel execution, and/or in a different order than shown in FIG. 2. At step 210A, the method 200A parses the first TCP/IP connections 106A, 108A, the second TCP/IP connections 106B, 108B, the third TCP/IP connections 106C, 108C and the fourth TCP/IP connections 106D, 108D into a common representation format; again, while shown as a single step following completion of steps 202, 204, 206 and 208 for simplicity of illustration this is not intended to be limiting, and (for example) in some embodiments separate parsing steps may follow each of steps 202A, 204A, 206A and 208A. At step 212A, the method 200A uses the common representation format to map dependencies in the network by differentiating the first TCP/IP connections 106A, 108A into first inbound TCP/IP connections 106A and first outbound TCP/IP connections 108A, differentiating the second TCP/IP connections 106B, 108B into second inbound TCP/IP connections 106B and second outbound TCP/IP connections 108B, differentiating the third TCP/IP connections 106C, 108C into third inbound TCP/IP connections 106C and third outbound TCP/IP connections 108C, and differentiating the fourth TCP/IP connections 106D, 108D into fourth inbound TCP/IP connections 106D and fourth outbound TCP/IP connections 108D.

The method 200A in FIG. 2A provides an illustrative alternate implementation. More preferably, however, the method 200 in FIG. 2 is used, which uses the OS-native scripts 110A, 110B, 110C, 110D to invoke the inbuilt OS-native utilities 112A, 112B, 112C, 112D and to parse the output of the OS-native utility into the common representation format locally on the respective server 102A, 102B, 102C, 102D before transmitting the data, already parsed into the common representation format, to the central system.

Important information to retrieve from the output of the OS-native utility and include in the common representation format includes established TCP/IP connections, listening ports, and host (server) IP addresses. In one illustrative, non-limiting implementation of step 210, each script 110A, 110B, 110C, 110D will take the output (active connection table and all configured IP addresses on the respective server 102A, 102B, 102C, 102D) and manipulate it using OS-native command line tools into a standard JSON format for export. One illustrative non-limiting sample format is:
[{“ips”:“data” }, {“1”:“data”}, {“e”:“data” }]
   wherein “ips” represents a list of IP addresses configured on the server, “1” represents a list of listening TCP ports on the server and “e” represents a list of currently established connections on the server. A populated example (using arbitrary IP addresses) is:
[{“ips”:“10.123.31.140”},{“1”:“22;11960;11961;4445;10.123.31.140:17472;17889;58625;10 050;3306;34700;111”},{“e”:“10.123.31.140:44848-10.123.31.140:3306”}]
   This is merely one example, and other common representation formats are also contemplated.

As noted above, the operating systems 104A, 104B, 104C, 104D may all be the same operating system, or may all be different operating systems, or may be a mix of various operating systems (or versions of operating systems). All operating systems that support TCP/IP have some mechanism for an operator to expose the current TCP/IP connection table; by using OS-native scripts which parse these outputs into a standard format, data from any TCP/IP-enabled server can be compared. For example, a first one of the servers 102A may run a first operating system 104A that is different from a second operating system 104B run by a second one of the servers 104B, with the first OS-native script 110A being native to the first operating system 104A and the second OS-native script 110B being native to the second operating system 104B. In a particular non-limiting illustrative example, the first operating system 104A is a Windows operating system and the second operating system is a Linux operating system 104B, the first OS-native script 110A runs the Windows NETSTAT utility and the second OS-native script 110B runs the Linux NETSTAT utility.

An illustrative, non-limiting sample script for Linux is:

#!/bin/bash
declare -a ltn
declare -a est
declare -a ntcmd
join ( ) {
IFS=″$1″
shift
echo ″$*″
}
ips=$(ip -o -4 a|awk ′!/127.0.0|169.254/ {gsub(/\/.*/,″″; print $4}′)
ntcmd=$(netstat -an|awk ′/tcp/ && !/tcp6|WAIT|SYN|127.0.0|169.254/ {gsub(/[ ]+/,″
″);gsub(/[ ]+$/,″″);$0=tolower($0);if(NR>2)print $4,$5,$6}′ OFS=′|′)
ltn=$(echo ″${ntcmd[@]}″|awk -F′|′ ′/listen/ {gsub(/0\.0\.0\.0:/,″″); print $1}′ OFS=′-′)
est=$(echo ″${ntcmd[@]}″|awk -F′|′ ′/established/ {print $1,$2}′ OFS=′-′)
echo ″[{\″ips\″:\″$(join \; ${ips[@]})\″},{\″1\″:\″$(join \; ${ltn[@]})\″},{\″e\″:\″$(join
\; ${est[@]})\″}]″

An illustrative, non-limiting sample script for AIX is:

declare -a ltn
declare -a est
declare -a ntcmd
join ( ) {
IFS=″$1″
shift
echo ″$*″
}
ips=$(ifconfig -a | awk ′/inet/ && !/inet6|127.0.0|--/ {gsub(/\/.*/,″″);print $2}′)
ntcmd=$(netstat -an | awk ′/tcp/ && !/tcp6|WAIT|SYN|CLOSED|127.0.0|169.254/
{gsub(/[ ]+/,″ ″);gsub(/[ ]+$/,″″); $0=tolower($0);print $4,$5,$6}′ OFS=′|′)
ltn=$(echo ″${ntcmd[@]}″|awk -F′|′ ′/listen/ {gsub(/0\.0\.0\.0/,″″);gsub(/\hat{ }\*\./,″:″);
print $1}′ OFS=′-′ | sed ′s/\(.*\)\./\1:/′)
esto=$(echo ″${ntcmd[@]}″|awk -F′|′ ′/established/ {print $1,$2}′ OFS=′-′)
est=$(echo ″${esto[@]}″ | sed -e ′s/\./:/4′ -e ′s/\(.*\)\./\1:/′)
echo ″[{\″ips\″:\″$(join \; ${ips[@]})\″},{\″1\″:\″$(join \; ${ltn[@]})\″},{\″e\″:\″$(join
\; ${est[@]})\″}]″

An illustrative, non-limiting sample script for Windows PowerShell is:

$sip = Get-NetIPAddress -AddressFamily IPv4
$sip = Write-Output($sip).IPAddress | Select-String -NotMatch ″127.0.0.1″
$sip = ″{″″ips″″:″″$sip″″}″.Replace(″ ″,″;″)
$a = Get-NetTCPConnection | Select local*,remote*,state | Select-String
′Listen|Established′ | Select-String -NotMatch ″127.0.0.1″
$all = $a | ForEach-Object {
$split = ($_ -split ″;+″) -split ″=+″
$lip = $split[1]
$lport = $split[3]
$fip = $split[5]
$fport = $split[7]
$state = ($split[9]) -split ″}″
Write-Output $lip′:′$lport′|′$fip′:′$fport′|′$state
}
$alstn = $all | Select-String ′Listen′ | ForEach-Object {
$split = $_ -split ″\|+″
$lip = ($split[0]).Replace(″0.0.0.0″,″″).Replace(″::″,″″)
Write-Output $lip | Select-String -NotMatch ″127.0.0.1″
}
$alstn = ″{″″1″″:″″$alstn″″}″.Replace(″ ″,″;″)
$aest = $all | Select-String ′Established′ | ForEach-Object {
$split = $_ -split ″\|+″
$lipprt = $split[0]
$ripprt = $split[1]
Write-Output ($lipprt+″ ″+$ripprt).Replace(″ ″,″-″)
}
$aest = ″{″″e″″:″″$aest″″}″.Replace(″ ″,″;″)
write-output ″[$sip,$alstn,$aest]″

In one embodiment, each script 110A, 110B, 110C, 110D will be invoked using an orchestration utility (e.g. orchestration utility 402 described below) which allows the remote execution of code followed by retrieval of outputs. Examples of suitable orchestration utilities include, but are not limited to, the Ansible® orchestration utility offered as an open source community project sponsored by Red Hat, Inc., the Puppet® orchestration utility offered by Puppet, Inc. having an address at 308 SW 2nd Ave. Fifth Floor, Portland, OR 97204, the Progress® Chef® (formerly Chef®) orchestration utility offered by Progress Software Corporation, having an address at 15 Wayside Rd, Suite 400, Burlington, MA 01803 and the Tanium® orchestration utility offered by Tanium Inc., having an address at 3550 Carillon Point, Kirkland, WA 98033, USA. Thus, while compatible with a range of vendor-specific proprietary software, the methods and systems according to the present disclosure do not require proprietary collection software to collect connection data—data can be collected via open tools, such as the Ansible orchestration utility.

In one embodiment, the orchestration utility will store the outputs generated by each server 102A, 102B, 102C, 102D, after parsing into the common format, to a common database (“raw” database) for later processing. In a particular embodiment, the “raw” database is used as a temporary storage location for the orchestration utility to place collected script output data, and is cleared as the data is read from it.

In one preferred embodiment, the orchestration utility will also collect load balancing configurations from load balancer devices to capture virtual IP addresses (“VIP”s), which can be conceptualized as virtual servers, VIP service ports, and pool members. Collecting this data allows load balancers to be included in the network mapping operation. This is advantageous as many applications will require users to connect via a load balancer. Load balancing configurations can be collected directly from appliances (physical or virtual) via API, Secure Shell Protocol (SSH) or other management protocols supported by the appliance vendor.

Preferably, the orchestration utility will run the scripts 110A, 110B, 110C, 110D on each server 102A, 102B, 102C, 102D at a set interval. The interval may be adjustable, with the understanding that the more frequently the scripts 110A, 110B, 110C, 110D are run, the more accurate the output data will be. By polling for information on a regular basis, mapping can be updated automatically over time. Thus, after step 212 described below, after the specified interval the method 200 may return to step 202.

Once the scripts 110A, 110B, 110C, 110D have been run to collect data about the inbound TCP/IP connections 106A, 106B, 106C, 106D and the outbound TCP/IP connections 108A, 108B, 108C, 108D and that data has been placed into the common database (“raw” database) by the orchestration utility, it is ready for processing at step 212 as described above.

In one embodiment, the data is read from the “raw” database by a “loader” application (e.g. loader service 408 described below), which is responsible for reading raw connection data in the common representation format and parsing it into its final format based on standard TCP/IP protocol logic. Thus, mapping dependencies in the network at step 212 of the method 200 and step 212A of the method 200A may comprise executing a network engineering protocol logic layer on the common representation format to differentiate among the active TCP/IP connections between the inbound TCP/IP connections 106A, 106B, 106C, 106D and the outbound TCP/IP connections 108A, 108B, 108C, 108D.

In one embodiment, for each server 102A, 102B, 102C, 102D, the “loader” application will retrieve IP addresses, listening ports, and established connections, for example from the “raw” database in the common representation format (e.g. the JSON entry), and then use this information to differentiate between the inbound TCP/IP connections 106A, 106B, 106C, 106D and the outbound TCP/IP connections 108A, 108B, 108C, 108D. For a particular server 102A, 102B, 102C, 102D, where one of the active TCP/IP connections is made to one of that server's IP addresses and bound to one of that server's listening ports, and the local port number is lower than the remote port number, that TCP/IP connection is considered to be an inbound connection; otherwise that TCP/IP connection is considered to be an outbound connection. An outbound TCP/IP connection is considered to be a dependency of that server, as the server needs a resource from a remote destination and initiates the communication to that destination. Conversely, an inbound TCP/IP connection is considered to be a dependency of the remote client connecting to that server. This logic provides directionality of the TCP/IP connections for the purpose of mapping; the direction of the TCP/IP connection denotes host dependencies. (Note that the remote client is a “client” of the server to which it is connecting;

a remote client may itself be a server in respect of other devices.) The processed (differentiated) TCP/IP connections can then be stored in a second database (a “dependency” database) which is formatted to provide the dependency mapping. For example, and without limitation, in one embodiment the dependency database may be a relational database.

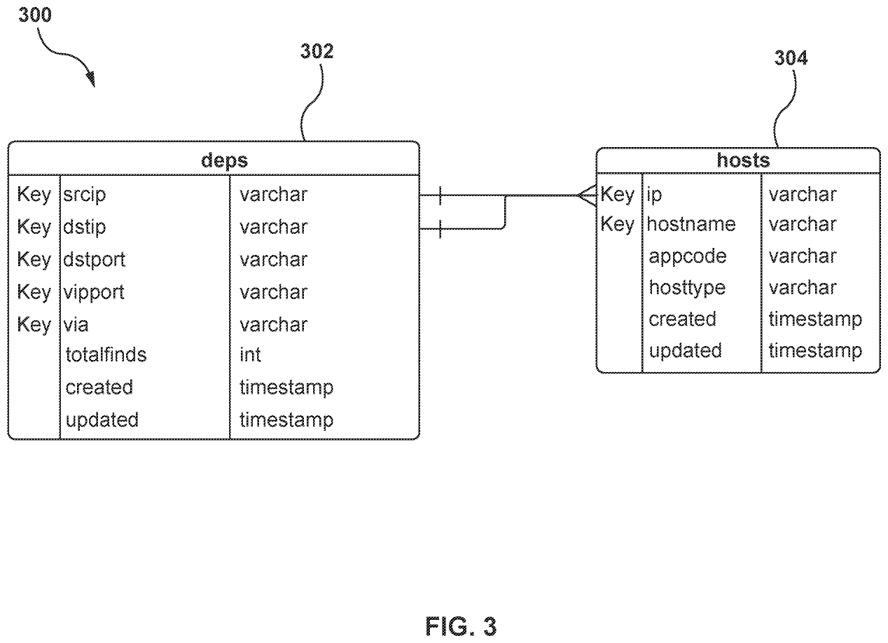

FIG. 3 shows an entity relationship diagram 300 for an illustrative, non-limiting implementation of the dependency database. A “deps” entity 302 represents the dependencies as rows in the relational database. More particularly, a specific instance of a “deps” entity represents one detected outbound connection from the source IP address to the destination IP address, along with the port used for communication. The “deps” entity 302 includes “srcip”, “dstip”, “dstport”, “created”, “updated”, “vipport”, “via” and “totalfinds” fields, defined as follows:
The “srcip” data field stores the source IP address of the TCP/IP connection;
The “dstip” data field stores the destination IP address of the TCP/IP connection;
The “dstport” data field stores the destination port number of the TCP/IP connection;
The “created” data field stores a creation timestamp for when the row was first created;
The “updated” data field stores an update timestamp for the most recent update of the row;
The “vipport” data field stores the TCP port used in the event that the “deps” entity 302 represents a virtual IP address or VIP;
The “via” field stores information on which specific IP address from a host is used to communicate to a specific destination IP address; and
The “totalfinds” field stores information about the number of times a particular dependency has been found.
   The “srcip”, “dstip”, “dstport”, “vipport” and “via” fields serve as keys for the “deps” entity 302.

For an outbound TCP/IP connection, the “srcip” data field (source IP address) will be a local IP address from the host and the “dstport” data field (destination port number) will be a remote port; for an inbound connection, the “srcip” data field (source IP address) will be the remote IP address and the “dstport” data field (destination port number) will be a local listening port on the host.

A host generally has one IP address from which it sends and receives data; however it is possible to configure hosts with multiple IP addresses. The “via” field is used to provide information on which specific source IP address from a host is used to communicate to a specific destination IP address. For a given host, if an outbound connection to a specific destination IP address is detected, but the host uses a different IP address to communicate with that destination IP address than the listed source IP address, that different IP address is recorded in the “via” field. Thus, where a host has multiple IP addresses, for a given connection:
The IP address from which the host reaches out to a destination should be recorded in the “srcip” data field (source IP address) for a “deps” instance; and
For each IP address on the host that is not a source of given connection, a “deps” instance should also be created with that IP address recorded in the “srcip” data field (source IP address), but with the “via” field populated with the actual source IP address for that connection.

The tuple of (srcip, dstip, dstport) within a “deps” instance provides information to describe the dependency relationship, including which host depends on which, along with the port used for communication, which may in some instances provide information on the specific communication application, e.g. dstport=123 would likely be used for the application “network time protocol”. As will be apparent to one of ordinary skill in the art, a particular relationship between the “dstport” field (destination port number) and a particular application is not guaranteed, as applications may use the recommended port number assignments or a different port number.

For a given pair (srcip, dstip), multiple “dstport” (destination port number) entries may exist in the database; this implies that the same two hosts are communicating using multiple applications.

The “totalfinds” field records how many times the same dependency has been detected, and the “updated” field is used to show when the “deps” instance for that dependency was last updated. Duplicate entries are detected based on the unique key (srcip, dstip, dstport, vipport); if a certain (srcip, dstip, dstport) tuple already exists in the database, that row is not overwritten. Instead, upon detection of a duplicate entry, the “totalfinds” field is incremented by 1, and the “updated” field is updated to the current date and time. The “created” field will show the time that a particular dependency was first entered into the database. Thus, the dependency database does not re-record connections each time they are discovered; rather, the loader tool simply updates the record timestamp. By the use of the “raw” database as temporary storage, and updating rather than re-recording connections, scalability for a large number of servers is supported. If centralized repositories of host (server) metadata exist, for example a configuration management database (CMDB), a host (server) metadata table can be created to enrich user output with data such as host ownership, type, etc. This data can also be retrieved at time of request, with the trade-off of performance.

The “created” and “updated” fields may be automatically generated timestamps.

A “hosts” entity 304 represents servers, and is designed to provide metadata for a given source IP address or destination IP address, including domain name system (DNS) hostname, application code and type. The “hosts” entity 304 includes the “ip” and “hostname” data fields as keys, representing, respectively, the IP address and the name of the particular server (domain name system (DNS) hostname). Additional fields in the “hosts” entity 304 include “appcode”, “hosttype” and “created” and “updated” fields similar to those for the “deps” entity 302.

The “hostname” field is populated with the DNS hostname, which is preferably queried from the organization's DNS servers as a source of truth. The “appcode” and “hosttype” fields store metadata associated with each IP address, which may be relevant in particular environments. For example, “appcode” may be a locally unique identifier (e.g. four digit code) for an application within an organization. In some embodiments, the “appcode” field records an identifier which ties the IP address to a specific owner and organizational unit, such as a business unit or department within a company. The “hosttype” field describes the function of a specific IP address, and may be derived from multiple sources. The “hosttype” may identify the operating system of the host (e.g. Linux OS or Windows OS) based on metadata collected by a CMDB, and may in some instances contain additional information. For example, a “hosttype” field entry may simply be “Windows Server”, or may be described with greater granularity or particularity as to function (e.g. “Active Directory Server”). If an organization has data sources for this information, these would be the primary source populating the “hosttype” field; additional sources may also be used. The detail provided in the “hosttype” field will be dependent on organizational requirements.

The “created” field will show the time that a particular host was first entered into the database. The “updated” field is used to prevent duplication; duplicate entries are detected based on the unique key (ip, hostname) and if a duplicate is detected, the “updated” field is overwritten with the current timestamp.

The “srcip” and “dstip” fields in the “deps” entity 302 can denote only a single instance of the “hosts” entity 304, but an instance of a “hosts” entity 304 may appear in multiple instances of a “deps” entity 302 (i.e. a particular server may be part of multiple dependencies). Preferably, all “deps” instances should be stored in a common database and should include the “updated” and “created” timestamp field to facilitate future data cleanup and scoped searches.

Once the data has been processed and is stored within the dependency database, it can be retrieved through a number of search patterns, depending on the use case:
Forward search: starting at a common source IP address, search for all rows which match that source IP address.
Forward tree search: starting at a common source IP address, search for all rows which match that source IP address (a first set of connections). Then from each set of destination IP addresses in that set, perform the same search, replacing the destination IP address with the source IP address in the search. This continues for a desired number of N iterations. For example, a user may enter the name of a server (e.g. “hostname” data field in the “hosts” entity 304) or an IP address (e.g. “ip” data field in the “hosts” entity 304) into a graphical user interface (GUI) and the system will search for all instances of the “deps” entity 302 for which the entered IP address appears in the “srcip” data field for an initial set with depth of 1. Then, for each instance of the “deps” entity 302 in the initial result set, the system will search for instances of the “deps” entity 302 for which the value in the “dstip” data field of the instance in the initial result set appears in the “srcip” data field of another instance of the “deps” entity 302; this is a second set with depth of 2. This process continues until the desired depth of N is reached.
Reverse tree search: starting at a common destination IP address, search for all rows which match that destination IP address. Then from each set of source IP addresses in that set, perform the same search, replacing the source IP address with the destination IP address in the search. This continues for a desired number of M iterations. For example, a user may enter the name of a server (e.g. “hostname” data field in the “hosts” entity 304) or an IP address (e.g. “ip” data field in the “hosts” entity 304) into a GUI and the system will search for all instances of the “deps” entity 302 for which the entered IP address appears in the “dstip” data field for an initial set with depth of 1. Then, for each instances of the “deps” entity 302 in the initial result set, the system will search for instances of the “deps” entity 302 for which the value in the “srcip” data field of the instance in the initial result set appears in the “dstip” data field of another instance of the “deps” entity 302; this is a second set with depth of 2. This process continues until the desired depth of M is reached.
Reverse search: starting at a common destination IP address, search for all rows which match that destination IP address.
“Top” or “volume” search: search for IP addresses which have either the most number of inbound or outbound connections.
Wildcard search: search for any string or set of strings within the data set, for example a specific IP address or set of IP addresses.
   These are merely some illustrative examples of search protocols; other search protocols are also contemplated.

The results of the forward tree search and reverse tree search denote dependency, with each destination IP address being a host upon which the associated source IP address depends. Thus, the mapping uses the inbound TCP/IP connections 106A, 106B, 106C, 106D and the outbound TCP/IP connections 108A, 108B, 108C, 108D to generate host dependencies according to the common representation format based on directions of the connections. Search types other than those listed are also contemplated. The data resulting from the search can be returned to the user via GUI or API, enriching with metadata if desired.

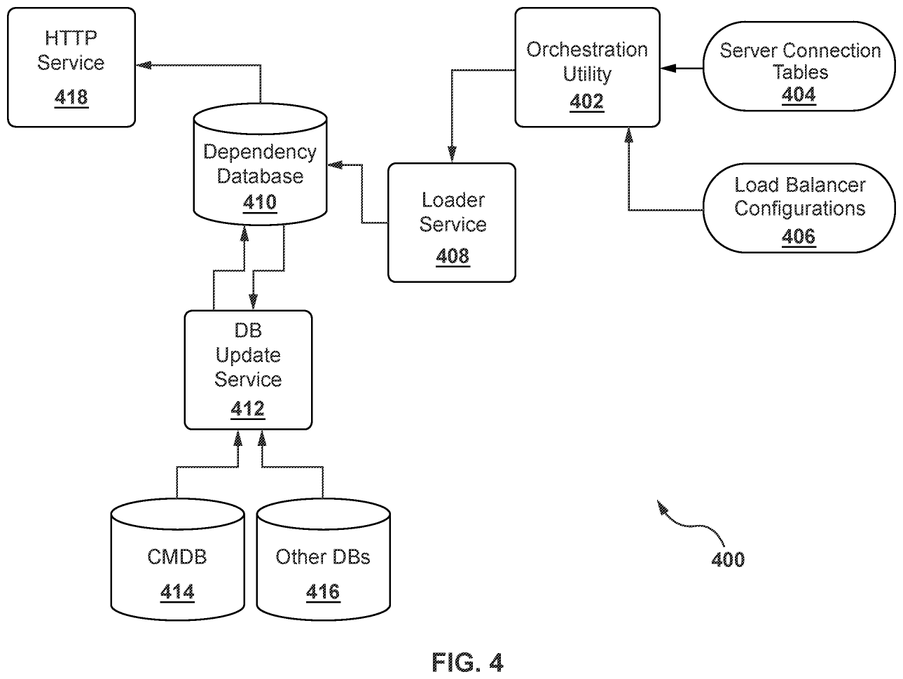

Reference is now made to FIG. 4, which shows an application flow 400 for an illustrative, non-limiting implementation of a system deployed in a cloud environment according to the present disclosure. An orchestration utility 402 invokes OS-native scripts on the servers, and receives server connection tables 404 containing established TCP/IP connections, listening ports, and host (server) IP addresses. For example, the orchestration utility 402 may receive the server connection tables 404 via NETSTAT at particular intervals. The orchestration utility 402 also optionally receives load balancer configurations 406, e.g. static configurations such as F5 configurations. The orchestration utility 402 passes the server connection tables 404 (or data therefrom) and any load balancer configurations 406 (or data therefrom) to a loader service 408. For example, although not shown in FIG. 4, the orchestration utility 402 may store the relevant data in the raw database in the common representation format, which can be passed to or read by the loader service 408. Load balancing configurations can be collected by the loader service 408, or the data can be collected and placed into a database for consumption by the loader service 408 asynchronously.

The loader service 408 will obtain IP addresses, listening ports, and established connections, for example from the raw database in the common representation format (e.g. the JSON entry). The loader service 408 then uses this information to differentiate between inbound TCP/IP connections and outbound TCP/IP connections and calculate dependency objects which can then be stored in the dependency database 410, for example using instances of the “deps” entity 302 and the “hosts” entity 304 described above. A database update service 412 maintains the objects in the dependency database 410, checks for data accuracy and prunes old (e.g. expired) dependencies. The database update service 412 may communicate with a CMDB 414 and one or more other databases 416. The loader service 408 may be run on a predefined schedule.

An HTTP service 418 provides access to the host (server) dependency information to end users, for example using a web-based GUI or an API interfacing with other software, and as can be seen is separate from the loader service 408 in the illustrated embodiment.

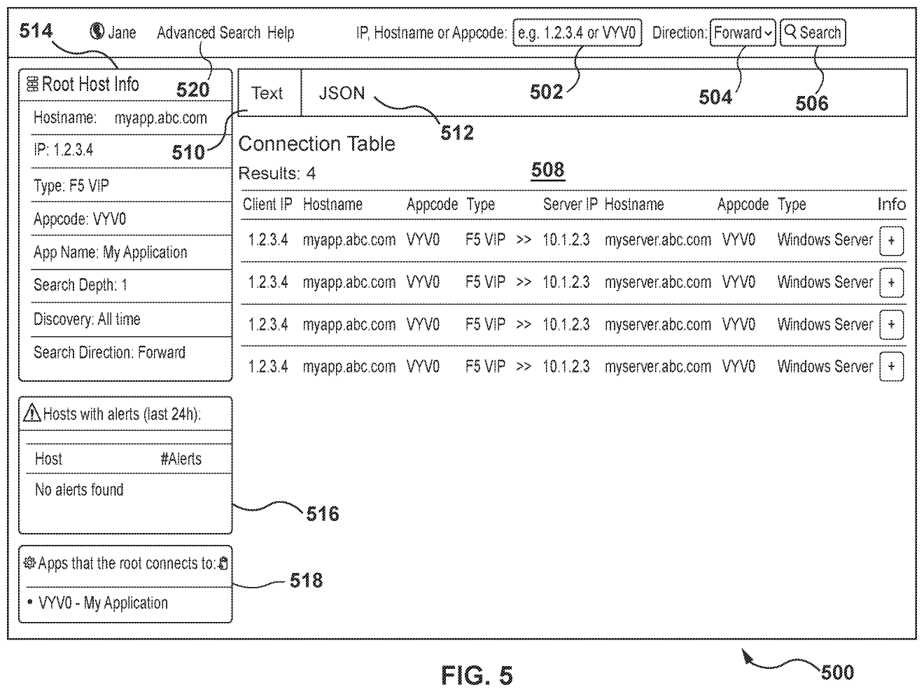

FIG. 5 shows an illustrative, non-limiting GUI 500 according to an aspect of the present disclosure. The GUI 500 includes a search box 502 to enter the IP address or host name of the root host, that is, the IP address from which the search will start, as well as a search direction selector 504 to specify the search direction (forward or reverse), and a search button 506 to initiate the search. The results of the search take the form of a connection table 508. Selecting the “Text” tab 510 as shown in FIG. 5 displays the connection table 508 using simple text; alternatively, selecting the “JSON” tab 512 displays the same connection table 508, but in JSON format (e.g. for use in an API). The “Root Host Info” box 514 displays a summary of search parameters and various metadata for the root host specified in the search box 502. An alerts box 516 can display any alerts associated with IP addresses in the connection table 508, and a connected applications box 518 summarizes and de-duplicates applications associated with the root host. An “Advanced Search” option 520 allows for changes to various default settings, such as search depth (which may default to 1). The references to “myapp.abc.com” and “myserver.abc.com” in FIG. 5 are intended to depict generic host names and do not refer to any actual legal entity.

The systems and methods disclosed herein can also be applied to detect unexpected connections, which may represent a security concern. For example, the plurality of servers may comprise initially known servers from an initial list, as well as one or more additional servers omitted from the initial list and identified from the host dependencies. Using the data in the dependency database, a list of servers identified either as a source of connections or a destination can be generated. This list can be compared to the original list of servers the orchestration utility is using, to detect gaps in that list. This functionality can be used to audit any database of servers in an enterprise, by looking at what is listed in the original list as compared to the servers that are actually communicating on the live network, to identify inaccurate or outdated lists. This functionality has security uses as well, for detecting servers for which no official database has record. These additional servers may (but do not necessarily) represent a security risk. For example, the additional server(s) may be an authorized server which was unintentionally omitted from the initial list or was added later without updating the original list. Or, the additional server(s) may represent an intrusion into the system by a nefarious actor. In some embodiments, a security test may be applied to the servers omitted from the initial list and identified from the host dependencies. Any server(s) omitted from the initial list and identified from the host dependencies and which fail the security test can be elevated as an urgent security risk for immediate investigation. For example, the communication pattern(s) of the server(s) omitted from the initial list can be compared to predetermined benign parameters and predetermined malign or suspicious parameters. A benign parameter may be periodic heartbeat communication with a known commercial software deployment server. A malign parameter may be frequent communication with an unknown endpoint, or any communication with an endpoint known to be associated with a threat actor, or with a geographic location which is suspicious given the context.

As can be seen from the above description, the network dependency mapping technology described herein represents significantly more than merely using categories to organize, store and transmit information and organizing information through mathematical correlations. The network dependency mapping technology is in fact an improvement to the technology of computer network management, as it calculates host dependencies based on real connection data, as opposed to metadata, to provide true relationships rather than estimates, and leverages built-in OS tools to avoid the need for specialized network “tap” hardware. Moreover, the network dependency mapping technology is applied in the context of particular machines, namely TCP/IP devices. As such, the network dependency mapping technology is confined to computer network management applications.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In a scenario where the connection is made through WAN or ISP, security accommodations would be needed to allow connectivity into the LAN. A “software as a service” (SaaS) implementation is also contemplated; this would also require the above security accommodations and/or a central collection agent within the LAN.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams (including application flow diagrams) of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

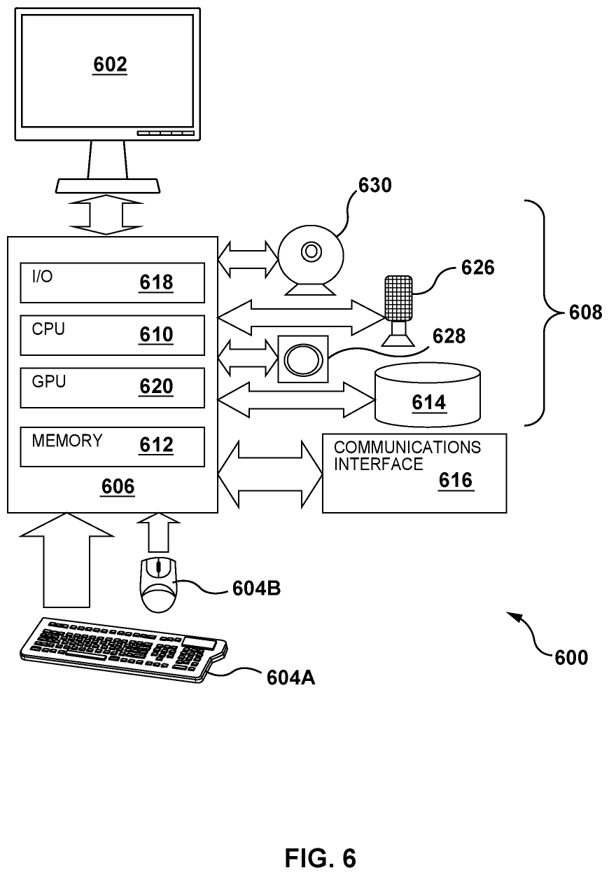

An illustrative computer system in respect of which the technology herein described may be implemented is presented as a block diagram in FIG. 6. For example, the illustrative computer system in FIG. 6 may be considered representative of a non-limiting example of one or more of the servers 102A, 102B, 102C, 102D. The illustrative computer system is denoted generally by reference numeral 600 and includes a display 602, input devices in the form of keyboard 604A and pointing device 604B, computer 606 and external devices 608. While pointing device 604B is depicted as a mouse, it will be appreciated that other types of pointing device, or a touch screen, may also be used.

The computer 606 may contain one or more processors or microprocessors, such as a central processing unit (CPU) 610. The CPU 610 performs arithmetic calculations and control functions to execute software stored in an internal memory 612, preferably random access memory (RAM) and/or read only memory (ROM), and possibly additional memory 614. The additional memory 614 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 614 may be physically internal to the computer 606, or external as shown in FIG. 6, or both.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604A, external devices 608 and other such components of the computer system 600. The computer 606 also includes a graphical processing unit (GPU) 620. The latter may also be used for computational purposes as an adjunct to, or instead of, the (CPU) 610, for mathematical calculations.

The external devices 608 include a microphone 626, a speaker 628 and a camera 630. Although shown as external devices, they may alternatively be built in as part of the hardware of the computer system 600. Some of these may be absent depending on the context.

The various components of the computer system 600 are coupled to one another either directly or by coupling to suitable buses.

The terms “computer system”, “computer”, “data processing system” and related terms, as used herein, are not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 612 of the computer 606, or on a computer usable or computer readable medium external to the computer 606, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A method for mapping network connections among a plurality of servers, the method comprising:
invoking a first inbuilt OS-native utility on a first one of the servers to identify first TCP/IP connections on the first one of the servers; and
invoking a second inbuilt OS-native utility on a second one of the servers to identify second TCP/IP connections on the second one of the servers;
parsing the first TCP/IP connections and the second TCP/IP connections into a common representation format; and
using the common representation format to map dependencies in the network by differentiating the first TCP/IP connections into first inbound TCP/IP connections and first outbound TCP/IP connections and differentiating the second TCP/IP connections into second inbound TCP/IP connections and second outbound TCP/IP connections.

2. The method of claim 1, wherein:
the first inbuilt OS-native utility is invoked by running a first OS-native script on the first one of the servers; and
the second inbuilt OS-native utility is invoked by running a second OS-native script on the second one of the servers;
parsing the first TCP/IP connections into the common representation format occurs on the first server; and
parsing the second outbound TCP/IP connections into the common representation format occurs on the second server.

3. The method of claim 1, wherein:
the first one of the servers runs a first operating system and the second one of the servers runs a second operating system;
the first operating system is different from the second operating system;
the first OS-native script is native to the first operating system; and
the second OS-native script is native to the second operating system.

4. The method of claim 1, wherein the plurality of servers comprises at least three servers, the method further comprising:
invoking a third inbuilt OS-native utility on a third one of the servers to identify third TCP/IP connections on the third one of the servers; and
parsing the third TCP/IP connections into the common representation format;
wherein using the common representation format to map dependencies in the network further comprises differentiating the third TCP/IP connections into third inbound TCP/IP connections and third outbound TCP/IP connections.

5. The method of claim 1, wherein:
the first inbuilt OS-native utility on the first one of the servers retrieves a first connection table; and
all active TCP/IP connections for the first one of the servers are extracted from the first connection table.

6. The method of claim 1, wherein differentiating the first TCP/IP connections into first inbound TCP/IP connections and first outbound TCP/IP connections comprises executing a network engineering protocol logic layer on the common representation format wherein:
where an active one of the first TCP/IP connections is made to one of the first server's IP addresses and bound to one of the first server's listening ports and a local port number is lower than a remote port number, that active one of the first TCP/IP connections is considered to be one of the first inbound TCP/IP connections; and
otherwise that active one of the first TCP/IP connections is considered to be one of the first outbound TCP/IP connections.

7. The method of claim 1, wherein the mapping uses the first inbound TCP/IP connections, the first outbound TCP/IP connections, the second inbound TCP/IP connections and the second outbound TCP/IP connections to generate host dependencies based on directions of the connections.

8. A computer program product comprising a tangible, non-transitory computer readable medium containing instructions which, when executed by at least one processor of a data processing system, causes the data processing system to implement a method for mapping network connections among a plurality of servers, the method comprising:
invoking a first inbuilt OS-native utility on a first one of the servers to identify first TCP/IP connections on the first one of the servers; and
invoking a second inbuilt OS-native utility on a second one of the servers to identify second TCP/IP connections on the second one of the servers;
parsing the first TCP/IP connections and the second TCP/IP connections into a common representation format; and
using the common representation format to map dependencies in the network by differentiating the first TCP/IP connections into first inbound TCP/IP connections and first outbound TCP/IP connections and differentiating the second TCP/IP connections into second inbound TCP/IP connections and second outbound TCP/IP connections.

9. The computer program product of claim 8, wherein:
the first inbuilt OS-native utility is invoked by running a first OS-native script on the first one of the servers; and
the second inbuilt OS-native utility is invoked by running a second OS-native script on the second one of the servers;
parsing the first TCP/IP connections into the common representation format occurs on the first server; and
parsing the second outbound TCP/IP connections into the common representation format occurs on the second server.

10. The computer program product of claim 8, wherein:
the first one of the servers runs a first operating system and the second one of the servers runs a second operating system;
the first operating system is different from the second operating system;
the first OS-native script is native to the first operating system; and
the second OS-native script is native to the second operating system.

11. The computer program product of claim 8, wherein the plurality of servers comprises at least three servers, the method further comprising:
invoking a third inbuilt OS-native utility on a third one of the servers to identify third TCP/IP connections on the third one of the servers; and
parsing the third TCP/IP connections into the common representation format;
wherein using the common representation format to map dependencies in the network further comprises differentiating the third TCP/IP connections into third inbound TCP/IP connections and third outbound TCP/IP connections.

12. The computer program product of claim 8, wherein:
the first inbuilt OS-native utility on the first one of the servers retrieves a first connection table; and
all active TCP/IP connections for the first one of the servers are extracted from the first connection table.

13. The computer program product of claim 8, wherein differentiating the first TCP/IP connections into first inbound TCP/IP connections and first outbound TCP/IP connections comprises executing a network engineering protocol logic layer on the common representation format wherein:
where an active one of the first TCP/IP connections is made to one of the first server's IP addresses and bound to one of the first server's listening ports and a local port number is lower than a remote port number, that active one of the first TCP/IP connections is considered to be one of the first inbound TCP/IP connections; and
otherwise that active one of the first TCP/IP connections is considered to be one of the first outbound TCP/IP connections.

14. The computer program product of claim 8, wherein the mapping uses the first inbound TCP/IP connections, the first outbound TCP/IP connections, the second inbound TCP/IP connections and the second outbound TCP/IP connections to generate host dependencies based on directions of the connections.

15. A data processing system comprising at least one processor and memory coupled to the at least one processor, wherein the memory stores instructions which, when executed by the at least one processor, cause the data processing system to implement a method for mapping network connections among a plurality of servers, the method comprising:
invoking a first inbuilt OS-native utility on a first one of the servers to identify first TCP/IP connections on the first one of the servers; and
invoking a second inbuilt OS-native utility on a second one of the servers to identify second TCP/IP connections on the second one of the servers;
parsing the first TCP/IP connections and the second TCP/IP connections into a common representation format; and
using the common representation format to map dependencies in the network by differentiating the first TCP/IP connections into first inbound TCP/IP connections and first outbound TCP/IP connections and differentiating the second TCP/IP connections into second inbound TCP/IP connections and second outbound TCP/IP connections.

16. The data processing system of claim 15, wherein:
the first inbuilt OS-native utility is invoked by running a first OS-native script on the first one of the servers; and
the second inbuilt OS-native utility is invoked by running a second OS-native script on the second one of the servers;
parsing the first TCP/IP connections into the common representation format occurs on the first server; and
parsing the second outbound TCP/IP connections into the common representation format occurs on the second server.

17. The data processing system of claim 15, wherein:
the first one of the servers runs a first operating system and the second one of the servers runs a second operating system;
the first operating system is different from the second operating system;
the first OS-native script is native to the first operating system; and
the second OS-native script is native to the second operating system.

18. The data processing system of claim 15, wherein the plurality of servers comprises at least three servers, the method further comprising:
invoking a third inbuilt OS-native utility on a third one of the servers to identify third TCP/IP connections on the third one of the servers; and
parsing the third TCP/IP connections into the common representation format;
wherein using the common representation format to map dependencies in the network further comprises differentiating the third TCP/IP connections into third inbound TCP/IP connections and third outbound TCP/IP connections.

19. The data processing system of claim 15, wherein:
the first inbuilt OS-native utility on the first one of the servers retrieves a first connection table; and
all active TCP/IP connections for the first one of the servers are extracted from the first connection table.

20. The data processing system of claim 15, wherein differentiating the first TCP/IP connections into first inbound TCP/IP connections and first outbound TCP/IP connections comprises executing a network engineering protocol logic layer on the common representation format wherein:
where an active one of the first TCP/IP connections is made to one of the first server's IP addresses and bound to one of the first server's listening ports and a local port number is lower than a remote port number, that active one of the first TCP/IP connections is considered to be one of the first inbound TCP/IP connections; and
otherwise that active one of the first TCP/IP connections is considered to be one of the first outbound TCP/IP connections.

21. The data processing system of claim 15, wherein the mapping uses the first inbound TCP/IP connections, the first outbound TCP/IP connections, the second inbound TCP/IP connections and the second outbound TCP/IP connections to generate host dependencies based on directions of the connections.
